(19) United States
(12) Patent Application Publication
(10) Pub. No.: US 2025/0361078 A1
(43) Pub. Date: Nov. 27, 2025

(54) COLLECTION STATION FOR POST-CONSUMER RECYCLABLE MATERIALS OR OTHER MATERIALS

(71) Applicant: D6 LLC, Sulphur Springs, TX (US)

(72) Inventors: Edward C. DOMINION, Bozeman, MT (US); John Matthew DE LIRA, Richardson, TX (US)

(21) Appl. No.: 19/214,971

(22) Filed: May 21, 2025

Related U.S. Application Data
(60) Provisional application No. 63/650,811, filed on May 22, 2024.

(51) Int. Cl. B65F 1/00; B65F 1/06; B65F 1/14; E04H 1/12; G06K 7/00; G07C 9/00

(52) U.S. Cl. CPC B65F 1/006; B65F 1/06; B65F 1/1426; E04H 1/1205; G06K 7/0004; G07C 9/00182; B65F 2210/108; B65F 2210/112; E04H 2001/1283; G07C 2009/00642; G07C 2009/0065

(57) ABSTRACT

A collection station for post-consumer recyclable materials or other materials includes a housing, which may be fabricated from an intermodal freight container, and multiple collection receptacles positioned within the housing under openings in side walls of the housing for depositing materials in the collection receptacles. Each opening and collection receptacle may be designated for a different type of recyclable material, facilitating segregation of the different types of recyclable materials. In some embodiments, an electronic access control unit including a code reader allows a user to unlock access doors covering the openings using a smartphone or other code-carrying device. A rechargeable battery and solar power system may provide power for the access control unit. The collection receptacles may include bag support frames supporting collection bags, and each bag support frame may be retractable against a wall of the housing to enable service access to collection receptacles behind the bag support frame.

### RELATED APPLICATION

This application claims the benefit of priority under 35 U.S.C. § 119 (e) from U.S. Provisional Patent Application No. 63/650,811, filed May 22, 2024, which is incorporated herein by reference.

### TECHNICAL FIELD

The field of the present disclosure relates to collection receptacles, particularly receptacles designed to be placed in publicly accessible spaces for collecting post-consumer recyclable materials.

### BACKGROUND

It is known to position receptacles in public spaces for collection of particular types of post-consumer recyclable materials, including large collection units that can be used to collect household recycling materials such as paper and plastic when curbside recycling is unavailable in a community, or for particular materials that are not accepted by curbside recycling programs. Some such receptacles have doors, small intake slots, or other features to limit access to the receptacle.

The present inventors have identified opportunities for improvements to collection receptacles for a variety of recyclable materials, including features for improved material handling and collection of recycling materials accumulated by individuals and households.

### SUMMARY

In one embodiment, a collection station for post-consumer recyclable materials called a community recycling unit (CRU) is fabricated in an intermodal freight container (better known as a “shipping container”) serving as a housing, and includes multiple locking access doors spaced apart along the long sides of the shipping container (e.g., two, three, four or more access doors on each side) for depositing different types of recyclable materials into multiple different bins or bags housed within the shipping container. The multiple access doors and bins facilitate segregation of different types of post-consumer recyclable materials, such as aluminum and/or other metals, clear plastic packaging including clamshell containers and others made from polyethylene terephthalate (PET), paper boxes, plastic bags and films made from low density polyethylene (LDPE), plastic bottles made from high density polyethylene (HDPE), plastic bottles made from PET, rigid food packaging made from polypropylene (PP), glass containers, and other materials. The access doors of the CRU are controlled by one or more computerized access control units, which may include an access control unit on each side of the shipping container, wherein each access control unit controls only the locks of those doors on the same side of the CRU as the access control unit. Each access control unit may include a QR code reader or other user interface that provides controlled access and/or allows all access to be restricted or denied when necessary or appropriate. Each of the access doors covers an opening in the housing and may be slidable or hinged to swing outwardly and reveal the opening, for depositing recyclable materials into the corresponding bin or bag within the shipping container. Photovoltaic solar panels on top of the shipping container provide electrical power to rechargeable batteries powering the computerized access control units.

In a further aspect of the present disclosure, a door mechanism for a CRU is mounted to an outer wall of a housing of the CRU, which may be formed of a shipping container. The door mechanism includes a pivoting tray assembly with an outer wall or panel covering an opening in the housing, two side walls or panels attached to the outer panel and extending inwardly into the housing through the opening, and an inner wall or panel extending through the opening in the housing in a direction transverse to the outer wall or panel. The inner wall or panel includes side edge portions attached to the side walls or panels, and a bottom edge portion attached to a bottom edge portion the outer wall or panel. The tray assembly is pivotable outwardly to an open position where the tray opens upwardly and is accessible outside of the housing for depositing recyclable materials into the tray assembly. The door mechanism further includes one or more pneumatic cylinders (aka gas springs or compressed air springs) or other spring mechanism attached at opposite ends thereof to the housing and one of the side walls or panels of the tray assembly to provide resistance to opening the access door and a biasing force for returning the door mechanism to the closed position. When the door mechanism is closed, the tray assembly is tipped inwardly to allow the recyclable materials that have been deposited into the tray to fall into a large collection bin or bag located within a housing of the CRU. Several different door mechanisms of this kind may be provided along each side of the housing of the CRU and in alignment with different bags or bins within the housing to thereby keep different types of recyclable materials segregated within the housing. A computer-controlled locking system of the CRU includes a mechanical or magnetic door latch of each of the door mechanisms that secures the outer panel of the door mechanism against the housing, selectively releases the door latches when a user requests access via a control panel, and re-locks the door latches after a timeout period.

In another aspect of the present disclosure, a folding bag frame structure is provided within the housing of the CRU for supporting a collection bag in a top-opening orientation. The bag frame is pivotably attached to the side wall of the housing of the CRU or otherwise movably attached to the housing so that the bag frame can be folded up against the side wall or otherwise retracted after a full collection bag is detached from the bag frame and removed from the CRU, to thereby allow service personnel to walk past the bag frame and access additional areas and collection bags located within the housing behind the bag frame. A first row of multiple bag frames may be attached to a first longitudinal side wall of the housing and a second row of multiple bag frames may be attached to a second longitudinal side wall of the housing opposite the first longitudinal side wall, with bag frames sized so that inner portions of the bag frames of the first row are adjacent inner portions of the bag frames of the second row, leaving little or no space between the first and second rows and maximizing the total collection volume of the CRU.

Additional aspects and advantages will be apparent from the following detailed description of preferred embodiments, which proceeds with reference to the accompanying drawings.

### BRIEF DESCRIPTION OF THE DRAWINGS

FIG. 1 is an isometric view of a community recycling unit (CRU) in accordance with a first embodiment, with an end wall of a housing of the CRU omitted to reveal bins within the CRU;

FIG. 2 is a front elevation view of the CRU of FIG. 1;

FIG. 2A is an auxiliary front elevation view of the CRU of FIG. 1 showing details of signage and solar panels of the CRU;

FIG. 3 is a side elevation view of the CRU of FIG. 1;

FIG. 4 is a longitudinal cross section elevation view of the CRU of FIG. 1 taken along lines 4-4, with bins omitted, and showing internal details including a control panel;

FIG. 5 is a longitudinal cross section elevation view of the CRU of FIG. 1 taken along lines 5-5, with bins omitted;

FIG. 6 is a detail view of the control panel of FIG. 4;

FIG. 7 is an isometric view of a CRU in accordance with a second embodiment;

FIG. 8 is a front elevation view of the CRU of FIG. 7;

FIGS. 9 and 10 are respective lateral and longitudinal elevational cross section views of the CRU of FIG. 7;

FIG. 11 is a cutaway top isometric view of the CRU of FIG. 7;

FIG. 12 is an isometric view of an access door mechanism of the CRU of FIG. 7 shown in a closed position;

FIG. 13 is a perspective view of the door mechanism of FIG. 12 shown in a partially open position;

FIGS. 14 and 15 are respective top and side views of the door mechanism of FIG. 12;

FIG. 16 is a pictorial view of an interior portion of the CRU of FIG. 7, showing detail the door mechanism of FIGS. 12-15 and a frame structure for a collection bag;

FIG. 17 is a pictorial view of an interior of an example CRU in accordance with another embodiment showing details of a collection bag attached to a frame structure of the kind illustrated in FIG. 16;

FIG. 18 is a side view of the door mechanism according to FIGS. 12-15 and bag frame illustrated in FIGS. 16-17, showing how the bag frame is pivotable between a lowered, deployed position and a raised, stowed position; and

FIG. 19 is a view of a clip used to attach the collection bag to the frame structure as illustrated in FIG. 17.

### DETAILED DESCRIPTION OF PREFERRED EMBODIMENTS

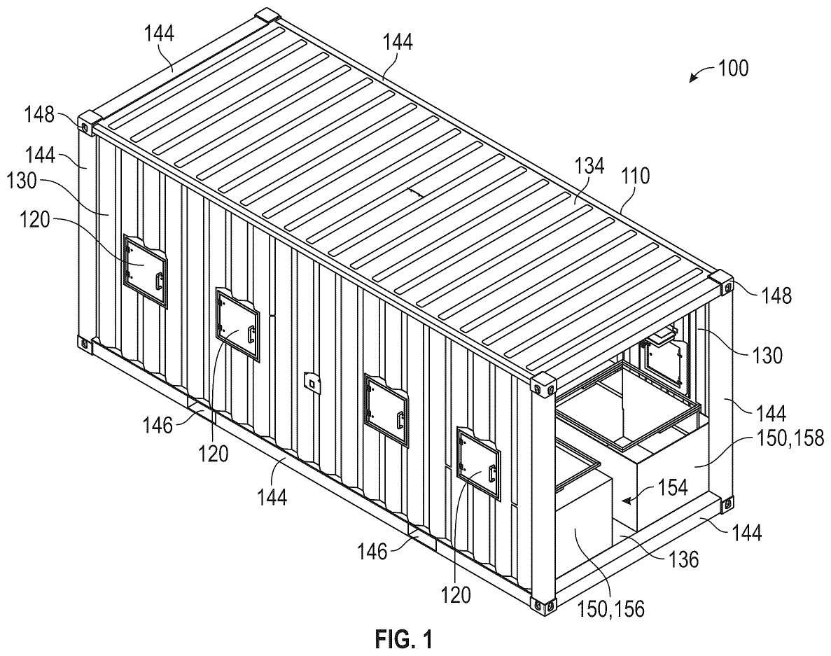

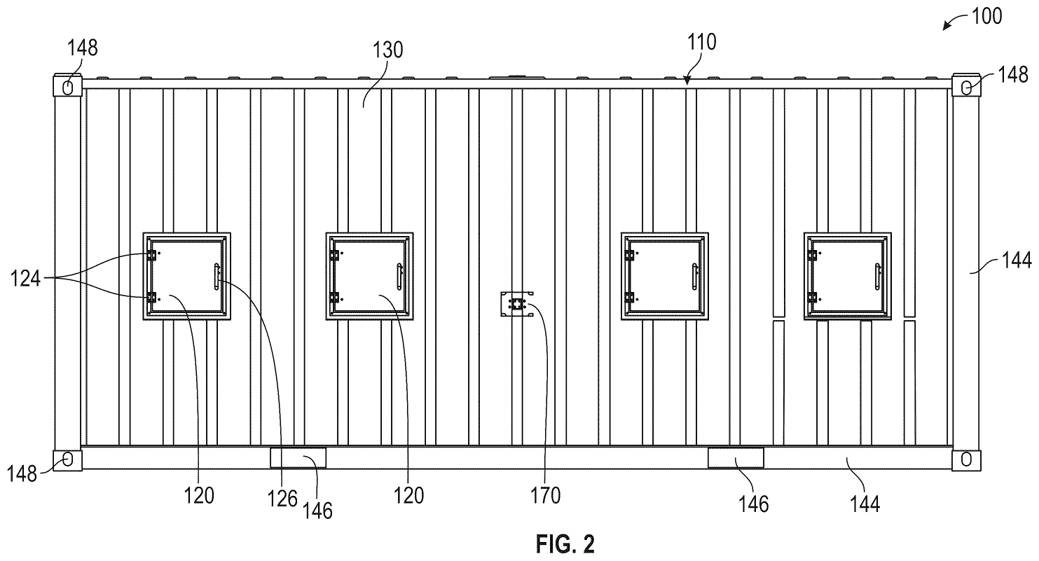

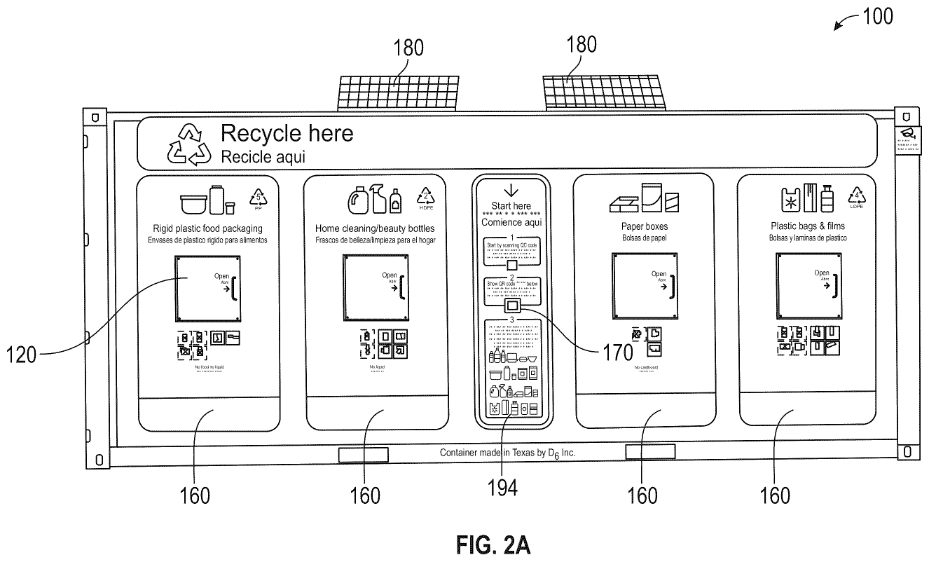

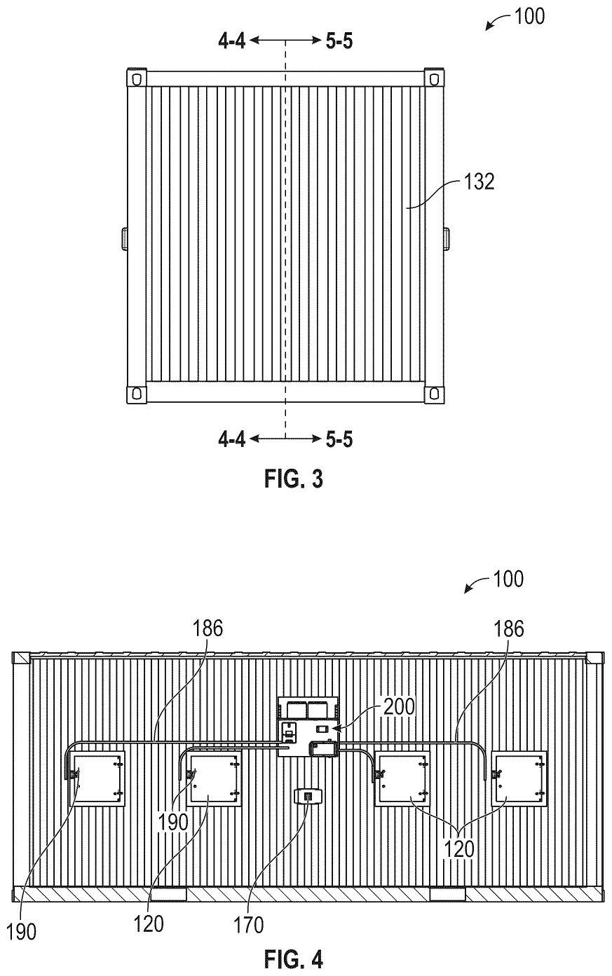

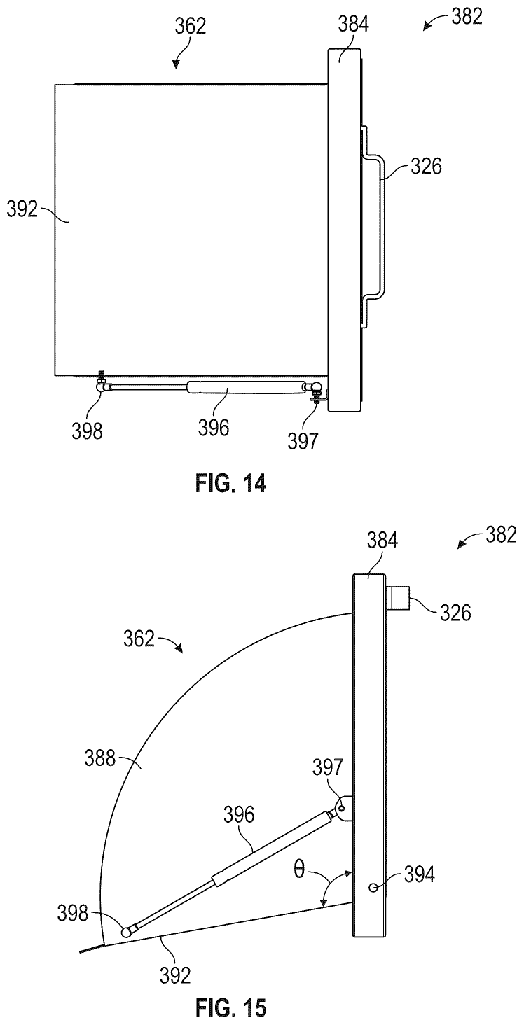

FIGS. 1 and 2 illustrate a collection station for recyclable materials, particularly household and consumer materials such as metal, plastic, and paper packaging materials and the like. With reference to FIGS. 1 and 2, the collection station, which will hereinafter be referred to as a Community Recycling Unit™ or CRU™ 100, includes a housing 110 fabricated from a shipping container, such as a standard 20-foot (5.9 m) long or 40-foot (12 m) long intermodal shipping container, or from another strong weatherproof housing structure, of which an end panel is omitted in FIG. 1 to reveal internal aspects of CRU 100 described below. In the embodiment illustrated, a row of four access doors 120 (aka deposit doors) is provided on each of the longitudinal side walls 130 (i.e. front and rear walls) of housing 110 for a total of eight access doors. In other embodiments a different number of access doors 120 is provided in CRU 100—for example one, two, four, six, ten or more doors, with one two, three, or more doors on each longitudinal side wall 130 and/or another wall of housing 110 such as an end wall 132 (FIG. 3). In the embodiment illustrated in FIGS. 1 and 2, the access doors 120 are pivotable about vertical hinges 124 (FIG. 2) located along a first side edge of the doors and the access doors 120 include handles 126 for opening the doors outwardly. In other embodiments, the access doors 120 may be slidable, hinged along a different edge, swinging, pivoting, or movable inwardly or in a different direction or manner to open and close the openings in housing 110. The access doors 120 may be installed at shoulder height (approximately 3 to 5 feet above ground level) and are sized to cover openings in the side walls 130 of housing 110 that may be square, rectangular or another shape and approximately 14 to 20 inches across—large enough to accommodate typical consumer packaging materials, but small enough to discourage or inhibit people from climbing into interior space 140, particularly when mailbox-style doors and tilting tray assemblies of the kind illustrated in the embodiment of FIGS. 7-16, described below, are utilized.

The opposing longitudinal side walls 130, end wall 132, top wall 134, and floor 136 of housing 110, and service doors at a second end opposite end wall 132 (not shown) of housing 110, may be made of corrugated metal and form a cuboid weatherproof enclosure that defines and encloses/borders an interior space 140 of CRU 100. Housing 110 may include a rigid tubular metal frame 144, a pair of forklift slots 146 in the bottom rails of frame 144, lift/connection points or openings 148 at the corners of frame 144, and other features typical of intermodal shipping containers, which may allow housing 110 to be easily transported by ship, rail or truck, and to be loaded onto and unloaded off of a ship, semi-trailer, train car, or other transport vehicle, and to be placed into service in a publicly-accessible location such as a parking lot. For example, CRU 100 may be delivered by a semi-trailer to and placed in a parking lot of a retail establishment, apartment complex, or other public or private lot accessible to the public. Conveniently, in the event that CRU needs to be removed from its location in a parking lot or otherwise moved, e.g. for service, or for commercial or safety reasons, the forklift slots 146 and standardized form factor as a shipping container allow the CRU 100 to be readily moved by any available shipping company capable of transporting intermodal freight containers.

A plurality of large bins 150 or other receptacles are provided within interior space 140 of CRU 100 in alignment with access doors 120, for receiving and collecting recyclable materials deposited into CRU 100. Bins 150 or other receptacles may range in size between about 25 cubic feet (ft³) and about 200 ft³, for example. A central aisle 154 may be left between first and second rows 156, 158 of the bins 150, to allow for service personnel to walk the length of housing 110 between the rows 156, 158 for servicing the CRU 100.

As illustrated in FIG. 2A, each access door 120 and bin 150 may be designated, e.g., via signage 160 on the outside of CRU 100, for a different type of post-consumer recyclable material. For example, a first one of the access doors 120 and its corresponding bin 150 may be designated for aluminum and/or other metals, a second one of the doors 120 (and its bin 150) for clear plastic packaging including clamshell containers and others made from polyethylene terephthalate (PET), a third one for paper boxes, a fourth one for plastic bags and films made from low density polyethylene (LDPE), a fifth one for plastic bottles made from high density polyethylene (HDPE), a sixth one for plastic bottles made from PET, a seventh one for rigid food packaging made from polypropylene (PP), and an eighth one for glass containers. In other embodiments, additional access doors and bins may be provided for collecting other materials. Thus, the arrangement of access doors 120 and corresponding bins 150 facilitates segregation of the collected recyclable materials by type.

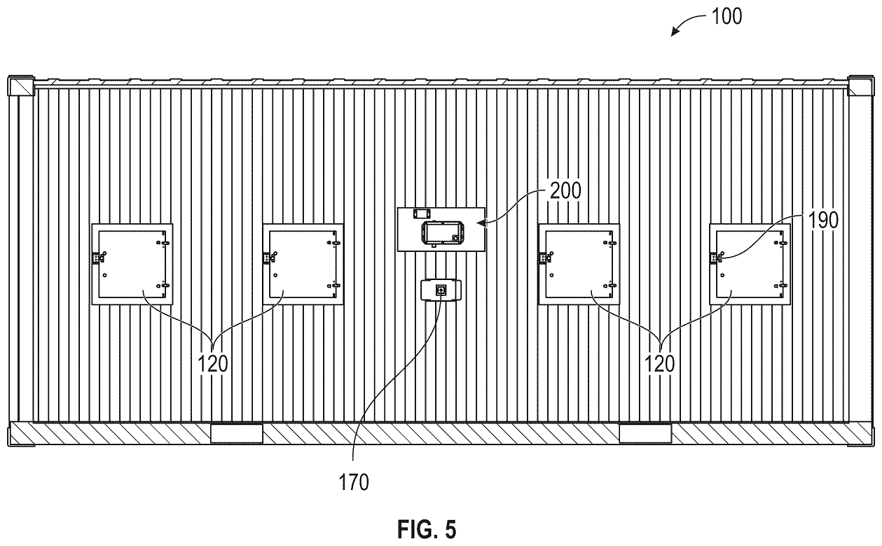

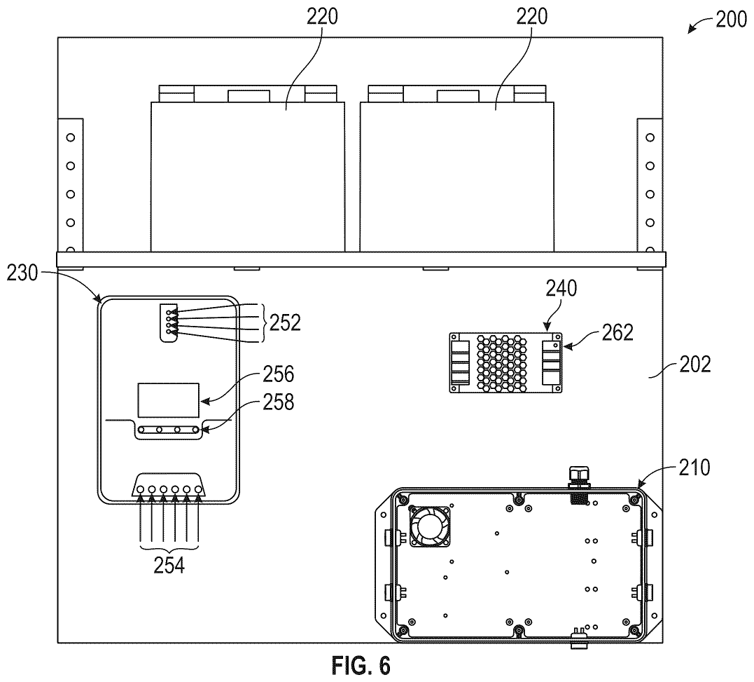

With reference to FIGS. 2, 2A, 4 and 5, each access door 120 of the CRU 100 is controlled by one or more computerized access control units 200 further described below with reference to FIG. 6, which may include first and second access control units mounted to an interior of respective front and rear side walls 130 of housing 110 for controlling locks and/or latches of the access doors 120. Each access control unit 200 may include or be coupled to a code reader 170, such as a QR code reader, a barcode scanner, a keypad, a radio transmitter such as a near-field communication (NFC) reader, or another user interface mounted to the corresponding side wall 130 and accessible from the outside of CRU 100. Code readers 170 and access control units 200 provide the ability to control access to CRU 100 and/or allow all access to be restricted or denied when necessary or appropriate. Wires may run through one or more electrical conduits 186 (FIG. 4, but omitted from FIG. 5) between control units 200 and solenoid activated locks or latch systems 190 of access doors 120, or motorized door openers (not illustrated). Photovoltaic solar panels 180 (FIG. 2A) on top of the housing 110 provide electrical power to rechargeable batteries 220 (FIG. 6) powering the computerized access control units 200 and code readers 170.

In operation, a user utilizes their smartphone camera to scan a static QR code printed on an instructional signage panel 194 (FIG. 2A), which activates a smartphone app or provides a URL to a website or internet-based resource that generates a new optically-readable security code, such as a barcode or QR code, on the user's smartphone screen. The user then holds their smartphone screen to the code reader 170, which reads the security code. In other embodiments, the access code could be carried by another kind of code-carrying device different from a smartphone, such as a card, paper printout, or RFID tag. Upon reading a valid security code via code reader 170, the control unit 200 energizes solenoids (not illustrated) of the latch systems 190 to unlock the access doors 120, or at least those access doors 120 on the same side of CRU 100 as the code reader 170 being used. The security code may be a one-time use code, a 2-factor authenticated code that is based on the unique user or device info and time stamp, or other secure or unique code to prevent unauthorized access and/or allow tracking of usage statistics. Usage statistics may be monitored by access control unit 200 to detect unusual frequency or patterns of access indicating potential misuse, and to revoke or suspend access to a particular user engaging in such misuse. After unlocking the access doors 120, after a predetermined timeout period, such as approximately 20 seconds, the control unit 200 may turn off the activation energy to re-lock the latch systems 190 and secure the access doors 120 in the closed position. Latch systems 190 may be spring loaded to allow doors to be closed and re-latched and locked after the timeout period elapses.

With reference to FIG. 6, the access control unit 200 of FIG. 4 is mounted on a main control panel 202 and includes a controller 210, such as a computerized controller, programmable logic controller (PLC) or other digital or analog control device, one or more electrical storage batteries 220, a solar controller 230, and a voltage regulator 240. In some embodiments (not illustrated), access control unit 200 may include a networked data communication device, such as a wired or wireless modem, cellular data transceiver, or other communication device for reporting usage statistics, error messages, and other information to a remote central station, and for receiving commands from the central station, such as a lockdown command. In the embodiment illustrated, the access control unit 200 on the rear side of CRU 100 (FIG. 5) only includes a controller and a voltage regulator, and shares the same batteries 220 and power supply/solar controller system with the main control unit 200 on the main control panel 202 of CRU 100. Solar controller 230 includes a set of main status indicators 252, which may be LEDs (light emitting diodes) or other lights or indicators, which indicate proper functioning of the power supply components (solar panels 180, batteries 220, etc.) or abnormalities, a set of power status indicators 254 indicating solar panel charge/discharge, load, and battery charge/discharge, a digital display panel 256, and a set of operating keys 258 or other user interface device. Voltage regulator 240 may also include a status indicator LED 262 or other indicator.

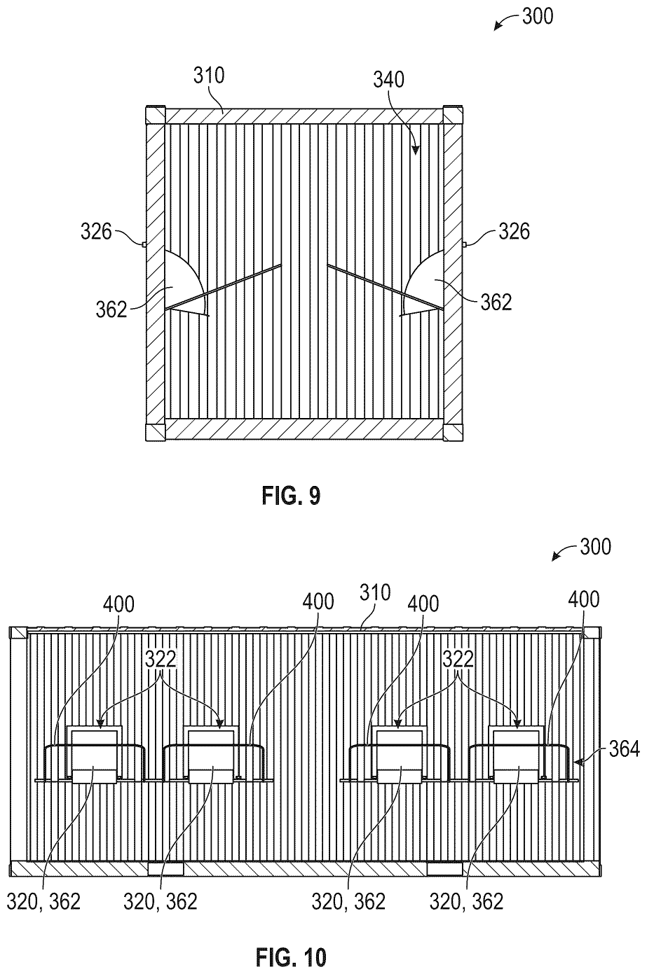

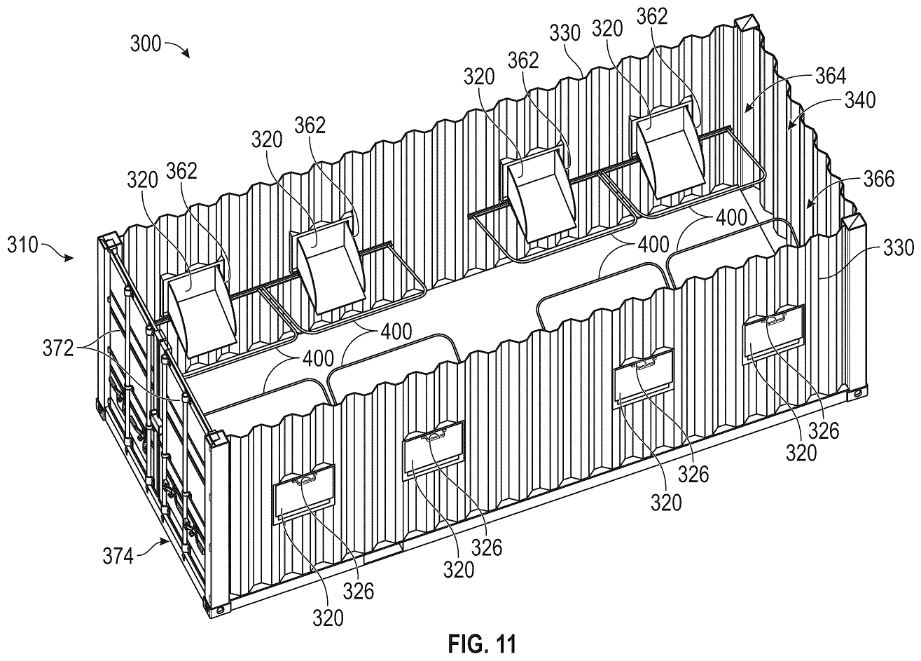

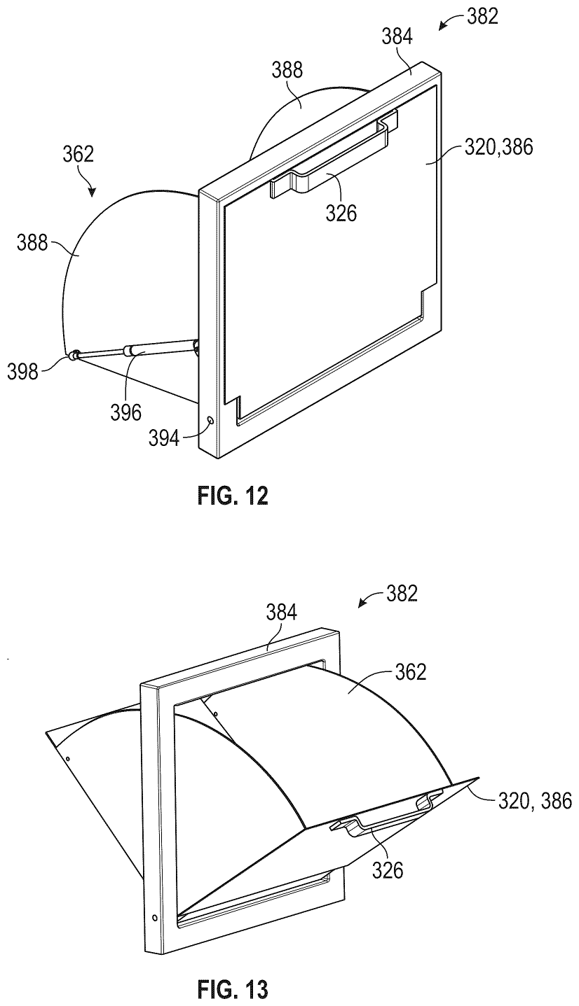

Turning now to FIGS. 7-19, a CRU 300 in accordance with a second embodiment includes multiple mailbox-style access doors 320, which are described in greater detail below with reference to FIGS. 12-15; and multiple bag support frames 400 (aka bag holder frames) for supporting collection bags, which are described in greater detail below with reference to FIGS. 9-11 and 16-19. CRU 300 includes a housing 310 fabricated from an intermodal shipping container, which may be the same as or similar to the housing 110 of CRU 100. CRU 100 may also include other identical or similar features which are not separately identified and described herein with reference to FIGS. 7-19 except certain components and portions in relation to the access doors 320 and bag support frames 400. Where possible, similar reference numerals are used herein to identify features common to CRU 300 and CRU 100.

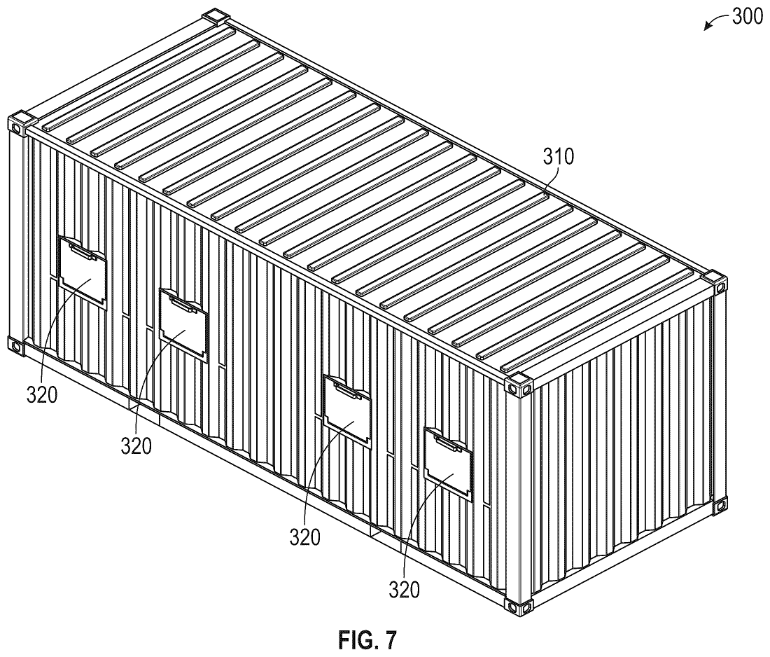

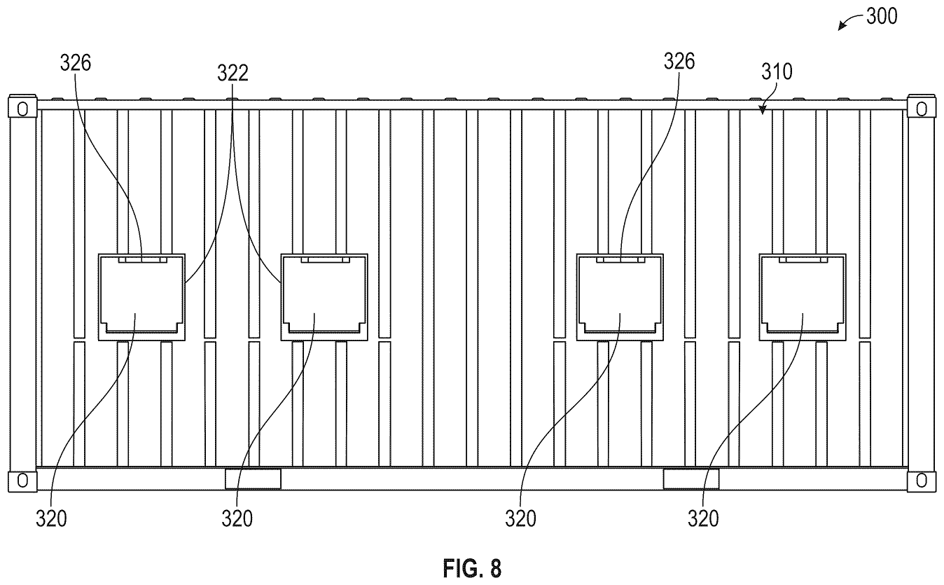

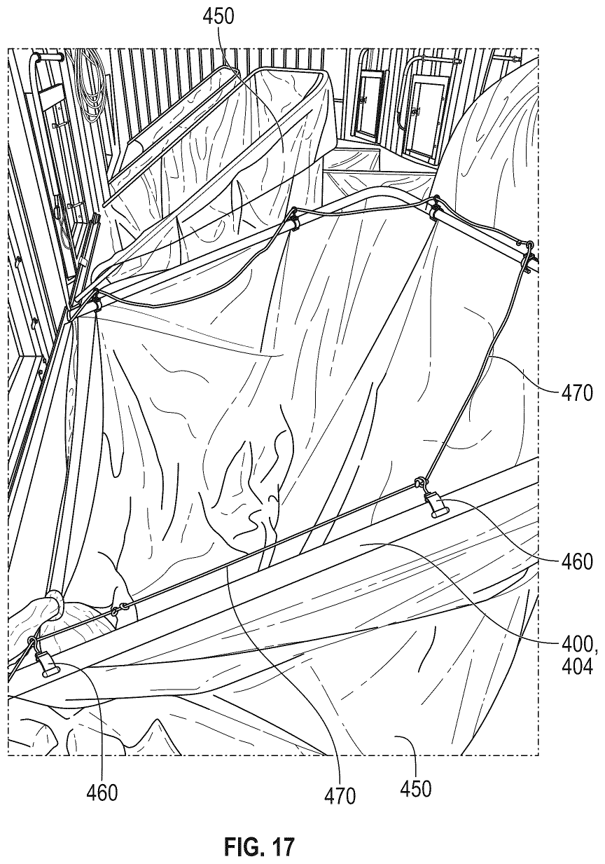

With reference to FIGS. 8-11, CRU 300 includes eight mailbox-style access doors 320, with four access doors 320 mounted in openings 322 formed in each of the front and rear longitudinal side walls 330 of housing 310. In other embodiments (not illustrated), access doors 320 and openings 322 might be included only on one side of the housing 310. Note that FIGS. 9-11 are simplified so that access control units of CRU 300 are omitted. Each access door 320 is pivotably mounted for rotation outwardly about a horizontal axis extending along a bottom edge portion of access door 320. Each access door 320 includes a pivoting tray assembly 362 that extends inwardly through its corresponding opening 322 into an interior space 340 of CRU 300. A handle 326 is attached to a top margin of an outer surface of each access door 320 for pulling access door 320 and pivoting tray assembly 362 outwardly to an open position, as illustrated in FIG. 13. FIGS. 10 and 11 also illustrate first and second rows 364, 366 of pivoting bag support frames 400 that are attached to respective rear and front side walls 330 of CRU and extend toward a longitudinal centerline (not indicated) of CRU 300. Collection bags 450 and attachment clips 460 illustrated in FIG. 17 are omitted from FIGS. 9-11 for simplicity and to avoid obscuring other details of CRU 300. Housing 310 includes one or more service doors, such as double-doors 372, at an end 374 of housing 310, allowing for service personnel to enter the interior space 340 of CRU 300 for servicing of equipment and for removal of collected recyclable materials from CRU 300 and transfer to a centralized sorting, storage, and/or recycling facility. The centralized facility (for sorting, storage, and/or recycling) is distant from CRU 300 and may receive recyclable materials from multiple CRUs and potentially other collection sites or sources. In some instances, such when service is needed, a new CRU may be swapped out for a full CRU 100 or 300 (including its housing and recyclable materials collected therein), which may be loaded onto a truck for transport of the entire unit and its recyclable materials to a centralized facility, while the new, empty CRU may be dropped in the parking lot in its place.

FIGS. 12-15 illustrate an access door mechanism 382 of CRU, including pivoting access door 320 and its attached pivoting tray assembly 362. FIGS. 12, 14, and 15 illustrate access door mechanism 382 in a closed position. FIG. 13 illustrates access door mechanism 382 in an open position with its access door 320 and pivoting tray assembly 362 tilted outwardly relative to a frame 384 of access door mechanism 382. Pivoting tray assembly 362 includes an outer panel 386 of access door 320 that is seated against or fitted into frame 384 to cover opening 322 (FIGS. 8, 10) when door mechanism 382 is in the closed position, two wedge-shaped sidewalls or side panels 388 attached to outer panel 386 and extending inwardly into the interior space 340 of housing 310 through the opening 322, and an inner panel 392 extending from a lower margin of outer panel 386 through opening 322. Inner panel 392 is oriented transversely of outer panel 386 and preferably forms an angle θ (FIG. 15) therebetween that is greater than 90 degrees, and preferably about 100 to 120 degrees, and more preferably about 110 degrees, so that when recyclable materials are deposited into tray assembly 362 and door mechanism is closed the recyclable materials slide off inner panel 392 and fall into the associated collection bag 450 (FIG. 17) that is supported by bag support frame 400. A bottom portion of pivoting tray assembly 362 is pivotably attached to frame 384 via pivot pins 394 best illustrated in FIGS. 12 and 15.

FIGS. 12, 14, and 15 are respective isometric, top, and side views illustrating details of pivoting tray assembly 362 and a pneumatic cylinder 396 (also known as a gas spring or compressed air spring) along a first side of access door mechanism 382. (Note: Pneumatic cylinder 396 is omitted from FIG. 13.) In some embodiments a second pneumatic cylinder may be provided along a second side of access door mechanism 382 opposite the first side. A first end 397 of pneumatic cylinder 396 is pivotably attached to frame 384 or directly to side wall 330 of housing 310, and a second end 398 of pneumatic cylinder 396 is pivotably attached to sidewall (side panel 388) of tray assembly 362. Pneumatic cylinder 396 may provide resistance to opening of access door mechanism 382 (including pivoting tray assembly 362) and/or a return force for returning the access door mechanism 382 and tray assembly 362 to the closed position and/or may dampen the opening and/or closing movement of door mechanism 382 and tray assembly 362. As in CRU 100, a mechanical or magnetic door latch system of each access door mechanism 382 of CRU 300 secures the outer panel 386 against the frame 384 and housing 310 when in the normally closed and locked position; and a computerized access control system of CRU 300 can be interfaced by a user to activate the door latch system to selectively unlock and release the door mechanism 382 for opening and depositing recyclable materials. Signage and the computerized access control system of CRU 300 are not illustrated, but may be the same as or similar to the signage 160, 194 and computerized access control unit 200 shown and described above with reference to FIGS. 2A and 4-6.

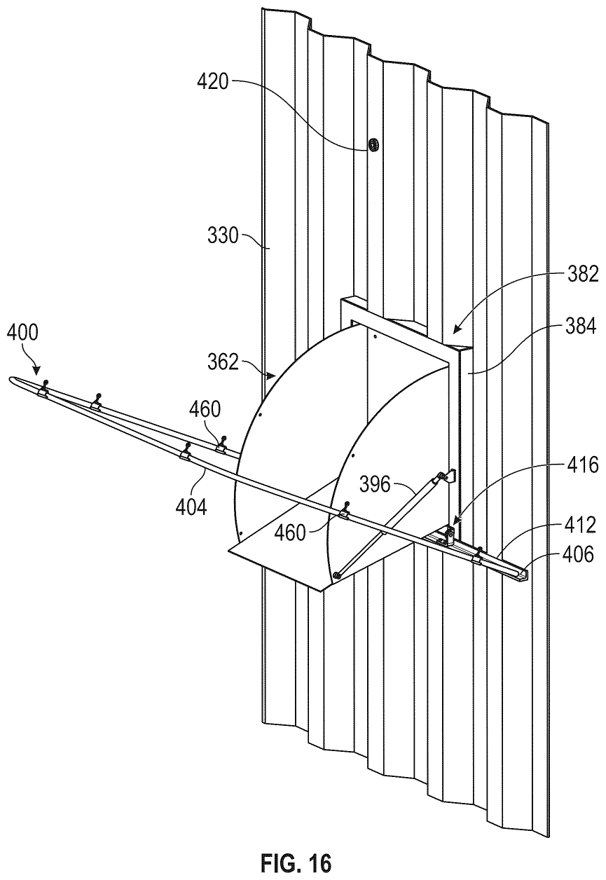

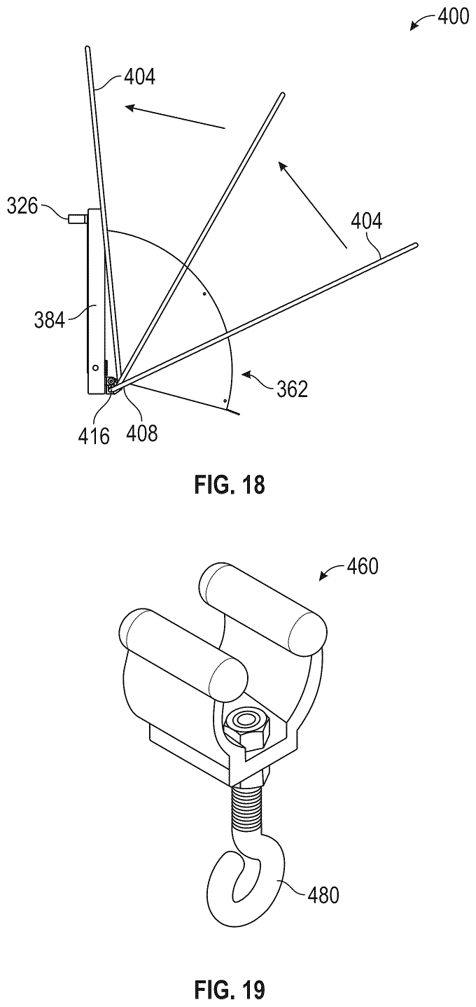

FIGS. 16-19 illustrate details of bag support frame 400 and associated hardware according to an embodiment. With reference to FIGS. 16 and 17, bag support frame 400 includes a bar 404 with three sides, such as a length of ½-inch aluminum or galvanized steel conduit bent into a rectangular U-shape. First and second ends 406, 408 of bar 404 are welded or otherwise securely attached to a base 412, which may be to a length of angle iron or angle aluminum. Base 412 sits adjacent side wall 330 of housing 310 below the frame 384 of access door mechanism 382 and is pivotably mounted to side wall 330 via hinge plates 416, so that support frame 400 may be folded upwardly against housing 310 by manually pivoting bar 404 and base 412 (as illustrated in FIG. 18). First and second ends 406 and 408 are spaced apart by a distance greater than a width of access door mechanism 382, and side portions of the support frame 400 (tines of the U-shape) are spaced apart by the same or greater distance. The base of the U-shape of bar 404, is spaced apart from base 412 and side wall 330 a distance at least 1.5 times (and preferably 1.5 to 2.5 times) a height of access door assembly 382 and/or at least 1.5 times (and preferably 1.5 to 2.5 times) an inwardly extending length of inner panel 392 of pivoting tray assembly 362. Bar 404 and base 412 are thus pivotable from a lowered, deployed position illustrated in FIGS. 9, 10, 11, 16 and 17, to a raised, stowed position best shown in FIG. 18.

A strong permanent magnet 420 is provided on an inside of side wall 330 above access door mechanism 382 to magnetically retain support frame 400 in the raised, stowed position when not in use, thereby allowing service personnel to gain unimpeded access to additional areas and collection bags located within the housing 310 behind the bag support frame 400 in its respective row 364 or 366. In another embodiment (not illustrated), a different kind of retainer than magnet 420 may be provided on the inside of side wall 330 to hold support frame 400 in the raised, stowed position when not in use. For example, a resilient C-clip may be mounted to the inside of side wall 330 in place of magnet 420, allowing bar 404 of support frame 400 to be snapped into the C-clip. In other embodiments, each of the bag support frames 400 may be movably mounted to, or supported by, housing 310 in a different manner, allowing the bag support frame 400 to be moved out of the way of a service person to allow access to collection bags or other items located behind the movable bag support frame 400.

A set of bag clips 460 illustrated in detail in FIG. 19 clip onto bar 404 to attach a collection bag 450 to bar 404 when in the deployed position, as depicted in FIG. 17. Bag clips 460 include resilient C-clips and a retainer loop 480. With reference to FIG. 17, a lanyard or retaining cord 470 is threaded through retainer loops 480 (FIG. 19) of the bag clips 460 to prevent bag clips 460 from being lost when detached from bar 404 for removal of collection bag 450.

Bag support frames 400 may desirably be sized so the bag support frames 400 of first row 364 (FIG. 11) are adjacent or nearly adjacent the bag support frames 400 of second row 366 (FIG. 11), leaving little or no space between the first and second rows 364, 366 (i.e. no aisle therebetween), thereby increasing the size and opening size of the collection bags 450 and the total collection volume of the CRU 300. In other embodiments (not illustrated), only a single row of doors, bag support frames 400 and collection bags 450 may be provided within the CRU.

It will be obvious to those having skill in the art that many changes may be made to the details of the above-described embodiments without departing from the underlying principles of the invention. For example, collection units similar to CRUs 100 and 300 may be used for purposes other than recycling, such as for collection and management of machined parts inventory in a manufacturing environment, collection and storage of fruit or vegetables in an orchard picking or farming environment, and mail and parcel collection. The scope of the present invention should, therefore, be determined only by the following claims.

The invention claimed is:

1. A collection station for post-consumer recyclable materials, comprising:
a housing fabricated from an intermodal freight container, the housing including opposing long sides and a service door at an end of the housing to allow human access to an interior of the housing;
multiple access doors each covering openings in a long side of the housing, each of the access doors including a latch to retain the access door in its closed position;
multiple collection receptacles, each collection receptacle positioned within the interior of the housing under one of the access doors;
the access doors being designated by signage on an exterior of the collection station to indicate different types of post-consumer recyclable materials for which the access doors and their corresponding collection receptacle are designated, wherein each of the access doors is designated by the signage for a different type of post-consumer recyclable material from others of the access doors to thereby facilitate segregation of collected recyclable materials by type; and
an access control unit including a code reader for reading an access code when presented by a user, the access control unit operably connected to the latch of each of the doors and configured to unlock one or more of the latches in response to the user positioning a code-carrying device carrying the access code near the code reader.

2. The collection station of claim 1, further comprising a photovoltaic solar panel on top of the housing that delivers electrical power a rechargeable battery within the interior of the housing that powers the access control unit.

3. The collection station of claim 1, wherein the code reader is an optical code reader, QR code reader, or barcode reader.

4. The collection station of claim 1, wherein the code-carrying device is a smartphone.

5. The collection station of claim 1, wherein the access code is unique to the user of the code-carrying device.

6. The collection station of claim 1, wherein the access code is generated in response to the user scanning an optical code visible on the exterior of the collection station, wherein each access code so generated is unique to an access session and the user.

7. The collection station of claim 1, wherein the access control unit collects usage statistics on each user's usage of the collections station.

8. The collection station of claim 1, wherein the access control unit is configured to report usage statistics and/or error messages to a remote central station.

9. The collection station of claim 1, wherein the latches are operable to unlock the access doors in response to the access control unit applying an activation energy to the latches.

10. The collection station of claim 1, wherein each of the receptacles includes a bag support frame mounted inside of the housing beneath its corresponding access door, the bag support frame being retractable.

11. The collection station of claim 10, wherein the bag support frame is pivotably mounted to an inside of the long side of the housing for pivoting movement upwardly to a retracted position.

12. The collection station of claim 11, further comprising a retainer mounted on the inside of the long side for releasably retaining the bag support frame in the retracted position.

13. The collection station of claim 1, wherein each of the access doors is biased toward the closed position by a pneumatic cylinder or a spring mechanism.

14. The collection station of claim 13, wherein each of the access doors includes a pivoting tray assembly pivotably mounted to the housing for rotation about a horizontal axis.

15. A collection station for materials, comprising:
a housing;
multiple openings in a side wall of the housing;
multiple collection receptacles, each collection receptacle positioned within the interior of the housing, each of the collection receptacles includes a bag support frame pivotably mounted to an inside of the side wall beneath the opening corresponding to the collection receptacle for supporting a collection bag under the opening to receive materials deposited through the opening, the bag support frames each being pivotable upwardly to a retracted position adjacent the side wall.

16. The collection station of claim 15, further comprising a retainer mounted on the inside of the long side for releasably retaining the bag support frame in the retracted position.

17. The collection station of claim 16, wherein the retainer is a permanent magnet.

18. The collection station of claim 15, wherein the bag support frames comprise a first row of bag support frames and the housing includes a second side wall opposite the side wall, and further comprising:
multiple openings in the second side wall;
a second row of collection receptacles each positioned adjacent to the second side wall under one of the openings in the second side wall, each of the collection receptacles of the second row including a second bag support frame pivotably mounted to an inside of the second side wall beneath the opening corresponding to said collection receptacle, the second bag support frames each being pivotable upwardly to a retracted position adjacent the second side wall.

19. The collection station of claim 18, wherein, the bag support frames of the first row are adjacent to the second bag support frames of the second row, leaving no aisle between the first and second rows when none of the bag support frames and second bag support frames are in the retracted position, thereby increasing the capacity of the collection station.
